(19) United States
(12) Patent Application Publication
(10) Pub. No.: US 2015/0005039 A1
(43) Pub. Date: Jan. 1, 2015

(54) SYSTEM AND METHOD FOR ADAPTIVE HAPTIC EFFECTS

(71) Applicants: Min Liu, Portland, OR (US); Mei Lu, Portland, OR (US); Ke Ding, Shanghai (CN)

(72) Inventors: Min Liu, Portland, OR (US); Mei Lu, Portland, OR (US); Ke Ding, Shanghai (CN)

(21) Appl. No.: 14/128,229

(22) PCT Filed: Jun. 29, 2013
(86) PCT No.: PCT/US2013/048798

§ 371 Date: Dec. 20, 2013

(51) Int. Cl. H04M 1/725; H04M 19/04

(52) U.S. Cl. CPC H04M 1/72569; H04M 19/047
USPC 455/567

(57) ABSTRACT

A user device including a haptic feedback system configured to receive and process data captured by one or more sensors and determine contextual characteristics of the user device and a surrounding environment based on the captured data. The contextual characteristics may include, but are not limited to, ambient noise level and ambient light level of the surrounding environment, as well as user possession, movement and/or use and interaction with the device. The haptic feedback system is further configured to adjust haptic feedback effects of the user device based, at least in part, on the contextual characteristics of the user device and surrounding environment so as to provide an optimized haptic feedback effect to the user.

### FIELD

The present disclosure relates to human-machine interaction, and, more particularly, to a system and method for providing adaptive haptic effects to a user of an electronic device based, at least in part, on contextual characteristics of the electronic device in relation to the surrounding environment.

### BACKGROUND

Haptic technology, or haptics, is a tactile feedback technology which takes advantage of a user's sense of touch by applying forces, vibrations and/or motions to the user. Haptic feedback is becoming more and more common in handheld mobile electronics, including cellular devices and tablet computing devices. As handheld mobile devices become part of everyday life, device manufactures and service providers strive to enhance the versatility and performance of such devices.

Some current handheld electronic devices include built-in haptic technologies configured to generate haptic effects as an alert or feedback mechanism. For example, some devices include haptic systems in the form of vibrators, for example, configured to produce mechanical vibrations, which are intended to be felt by a user of the device as an alert or feedback mechanism. For example, some handheld electronics include a touchscreen display configured to provide tactile stimulation in the form of vibrations in response to a user making contact with the touchscreen, such as when inputting data and/or making a selection on the graphical user interface of the touchscreen. Additionally, some cellular devices may be configured to vibrate in response to an incoming call and/or other type of incoming message (e.g. text, email, etc) or notification (e.g. tweet, post on social media app, etc.) so as to alert the user of the incoming call, message and/or notification.

While existing haptic technology may generally provide a more versatile user experience, current haptic feedback methods have some drawbacks. In particular, current haptic technologies are generally configured to produce fixed, predefined haptic effects (e.g. vibration waveform and strength), regardless of the local context of the device (e.g. the characteristics of the device in relation to the immediate surrounding environment). Although some current haptic technologies are configured to adjust haptic effects based on global context of the device, such as time and/or location, current haptic technologies fail to take into account local context for adjustment of the haptic effects, thereby compromising the user experience on mobile devices.

For example, a user may be located in a particularly noisy setting, such as a restaurant. In the event that the user is receiving an incoming call on their mobile phone, the user may be unable to hear the ringtone over the ambient noise within the restaurant. Furthermore, the noise level may be sufficient enough to distract the user such that the user may be oblivious to any physical vibrations (haptic effects) that may be accompanied with the ringtone or occurring when the phone is in a muted setting, thereby resulting in the user missing the incoming call. Furthermore, physical placement of the mobile phone may also play a role in whether the user will be alerted by existing haptic feedback methods. For example, vibrational effects may be easier for the user to notice when the user is in direct physical contact with the mobile phone (e.g. holding the phone), as opposed to when the mobile phone is stored within a pocket of the user's clothing or within personal items (e.g. bag, purse, backpack, etc.). As such, the fixed, predefined vibration may be more noticable when the mobile phone is within the user's hand and will likely go unnoticed when stored elsewhere.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is a block diagram illustrating one embodiment of a system for providing adaptive haptic effects to a user of a user device consistent with the present disclosure;

FIG. 2 is a block diagram illustrating another embodiment of a system for providing adaptive haptic effects to a user of a user device consistent with the present disclosure;

FIG. 3 is a block diagram illustrating the user device of FIG. 1 in greater detail;

FIG. 4 is a block diagram illustrating a portion of the user device of FIG. 3 in greater detail;

FIG. 5 is a block diagram illustrating another portion of the user device of FIG. 3 in greater detail; and

FIG. 6 is a flow diagram illustrating one embodiment for providing adaptive haptic effects to a user of a user device consistent with present disclosure.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient.

### DETAILED DESCRIPTION

By way of overview, the present disclosure is generally directed to a system and method for providing adaptive haptic effects to a user of a user device based, at least in part, on local contextual characteristics associated with the user device and the surrounding environment. The user device may include a haptic feedback system configured to receive and process data captured by one or more sensors and determine contextual characteristics of the user device and surrounding environment based on the captured data. The contextual characteristics may include, but are not limited to, characteristics related to the user device, including active use of the device (e.g. user is interacting with user device) and location of the device in relation to the user (e.g. in physical contact with the user stored in an article of clothing or personal items, etc.), and characteristics of the surrounding environment, including, for example, ambient noise level and ambient light level. The contextual characteristics may also include other characteristics of the user device, such as, for example, battery level, time and/or location.

The haptic feedback system is further configured to adjust haptic feedback effects of the user device based, at least in part, on one or more contextual characteristics of the user device, surrounding environment and/or global context (e.g. time and location) in response to an incoming signal (e.g. incoming call, text, email, notification, etc.) associated with generation of a haptic effect. More specifically, the user device may include a haptic device, such as, for example vibration actuator, configured to generate haptic effects (e.g. vibrations) in response to, for example, user input and/or incoming call, message or notification. The haptic feedback system may be configured to dynamically adjust me or more properties of the vibration effect, including, but not limited to, intensity (e.g. strength), waveform and duration, based, at least in part, on the contextual characteristics so as to provide an optimized haptic feedback effect to the user.

A system and method consistent with the present disclosure provides a means of dynamically adapting the delivery of haptic effects from an electronic device to a user based, at least in part, on the local contextual characteristics of the user device and surrounding environment. More specifically, the system is configured to adjust haptic effects so as to compensate for the contextual characteristics, including, but not limited to, ambient noise and light levels of the surrounding environment in relation to the device, the user's possession of the device, and/or the user's active usage of the device. The system is configured to adjust the haptic effects based on a combination of the contextual characteristics, thereby providing a more robust context determination. By adjusting the haptic effects to compensate for local context of the electronic device within the surrounding environment, the system is configured to provide optimized haptic feedback effects for the user, thereby enhancing overall user experience.

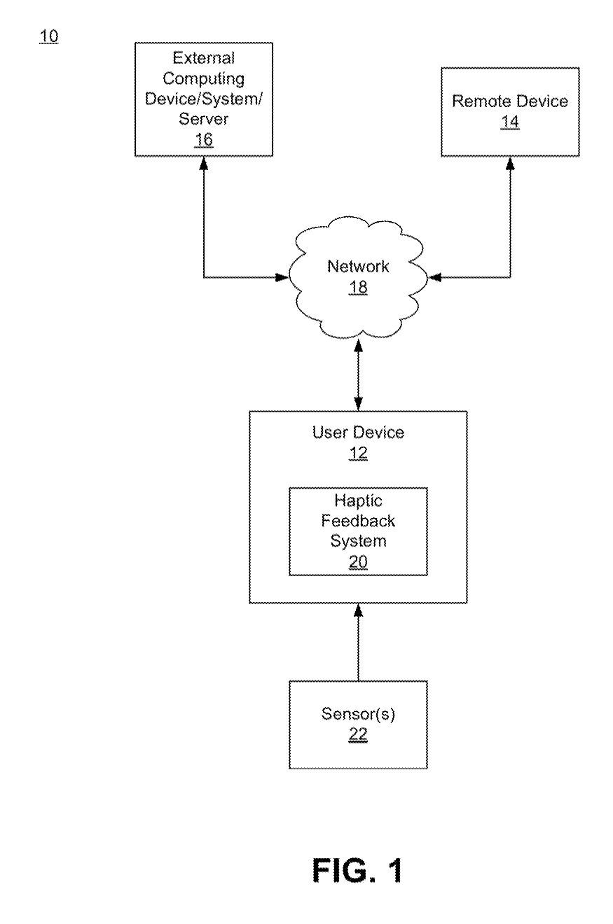

Turning to FIG. 1, one embodiment of a system 10 for providing adaptive haptic effects to a user of a user device 12 is generally illustrated. The system 10 includes a user device 12 configured to be communicatively coupled to at least one remote device 14 and/or an external computing device/system/server 16 via a network 18. The user device 12 may be embodied as any type of mobile device for communicating with the remote device 14 and/or the external computing device/system/server and for performing the other functions described herein. The mobile device 12 may include, but is not limited to, mobile telephones, smartphones, tablet computers, notebook computers, ultraportable computers, ultra mobile computers, netbook computers, subnotebook computers, personal digital assistants, enterprise digital assistants, mobile internet devices and personal navigation devices. Small form factor (SFF) devices, a subset of mobile devices, typically include hand-held mobile devices (i.e., hand-held devices with at least some computing capability).

The remote device 14 may likewise be embodied as any type of device for communicating with one or more remote devices/systems/servers. Example embodiments of the remote device 14 may be identical to those just described with respect to the user device 12. The embodiments of the remote device 14 may also be any other network connected devices that are not categorized as mobile computing devices. Examples of the other network connected devices include, but are not limited to, network connected home appliances, network connected security systems. The external computing device/system/server 16 may be embodied as any type of device, system or server for communicating with the user device 12 and/or the remote device 14, and for performing the other functions described herein. Examples embodiments of the external computing device/system/server 16 may be identical to those just described with respect to the user device 12 and/or may be embodied as a conventional server, e.g., web server or the like.

The network 18 may be any network that carries data. Non-limiting examples of suitable networks that may be used as network 18 include Wi-Fi wireless data communication technology, the interact, private networks, virtual private networks (VPN), public switch telephone networks (PSTN), integrated services digital networks (ISDN), digital subscriber link networks (DSL), various second generation (2G), third generation (3G), fourth generation (4G) cellular-based data communication technologies, Bluetooth radio, Near Field Communication (NFC), other networks capable of carrying data, and combinations thereof. In some embodiments, network 18 is chosen from the internet, at least one wireless network, at least one cellular telephone network, and combinations thereof. In alternative embodiments, the communication path between the user device 12 and the remote device 14 and/or between the user device 12 and the external computing device/system/server 16, may be, in whole or in part, a wired connection.

The user device 12 is configured to initiate and/or receive communication with at least one of the remote device 14 and external computing device/system/server 16 via the network 18. In one example, the user device 12 may receive an incoming communication from the remote device 14 in the form of a phone call and/or other type of incoming message, such as text messaging. Other types of incoming communications may include, but are not limited to, entails, notifications from social media applications (e.g. tweets, posts, blogs, etc.) and alert messages from home appliances. Additionally, the user device 12 may further be configured to receive internally stored notifications, such as, for example, scheduled calendar events and alarms. As generally understood, the user device 12 may be configured to generate and provide an audible alert to a user via an audio means (e.g. integrated speaker) in response to an incoming communication, thereby alerting the user of the incoming communication.

The user device 12 further includes a haptic feedback system 20 configured to provide adaptive haptic effects in response to, for example, incoming communications. The haptic effects are generally configured to provide a means of alerting the user of the incoming communication, in addition to, or in substitute of, the generated audible alert. As described in greater detail herein, the haptic feedback system 20 is configured to receive data captured by one or more sensors 22, wherein the data is related to the user device 12 and surrounding environment. As used herein, the term “surrounding environment” may generally refer to the immediate environment or setting in which the user device 12 is positioned. The haptic feedback system is further configured to determine contextual characteristics of the user device 12 and surrounding environment based on the captured data. The contextual characteristics may include, but are not limited to, characteristics related to the user device, including active use of the device (e.g. user is interacting with user device) and location of the device in relation to the user (e.g. in physical contact with the user, stored in an article of clothing or personal items, etc.), and characteristics of the surrounding environment, including, for example, ambient noise level and ambient light level. The contextual characteristics may also include global context of the user device, such as time and/or location. The haptic feedback system 20 is further configured to adjust haptic feedback effects of the user device based, at least in part, on the contextual characteristics of the user device and surrounding environment.

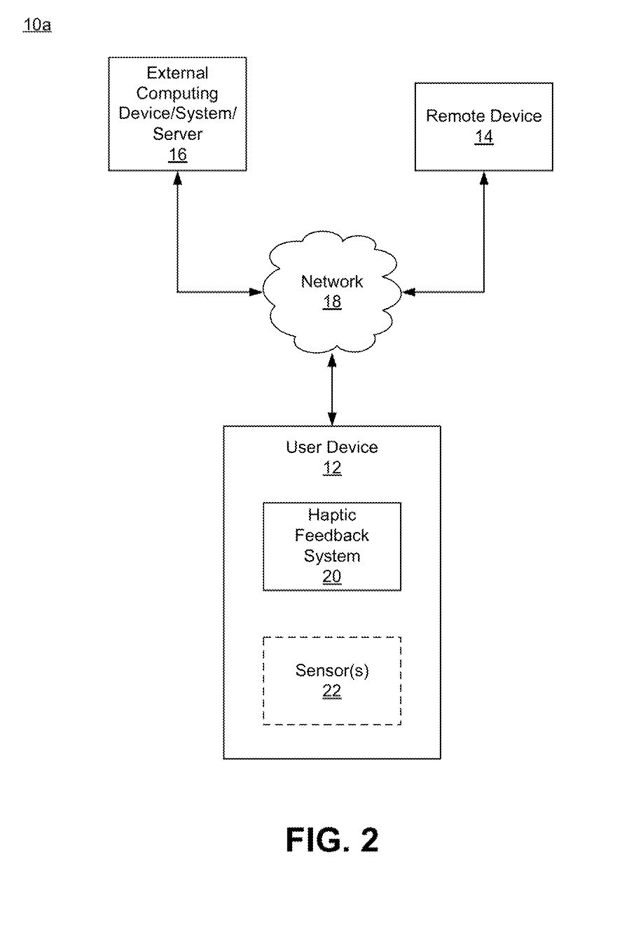

In the illustrated embodiment, the user device 12 and the one or more sensors 20 are separate from one another. It should be noted that in other embodiments, as generally understood by one skilled in the art, the user device 12 may optionally include the one or more sensors 20, as shown in the system 10a of FIG. 2, for example. The optional inclusion of the one or more sensors 20 as part of the user device 12, rather than elements external to user device 12, is denoted in FIG. 2 with broken lines.

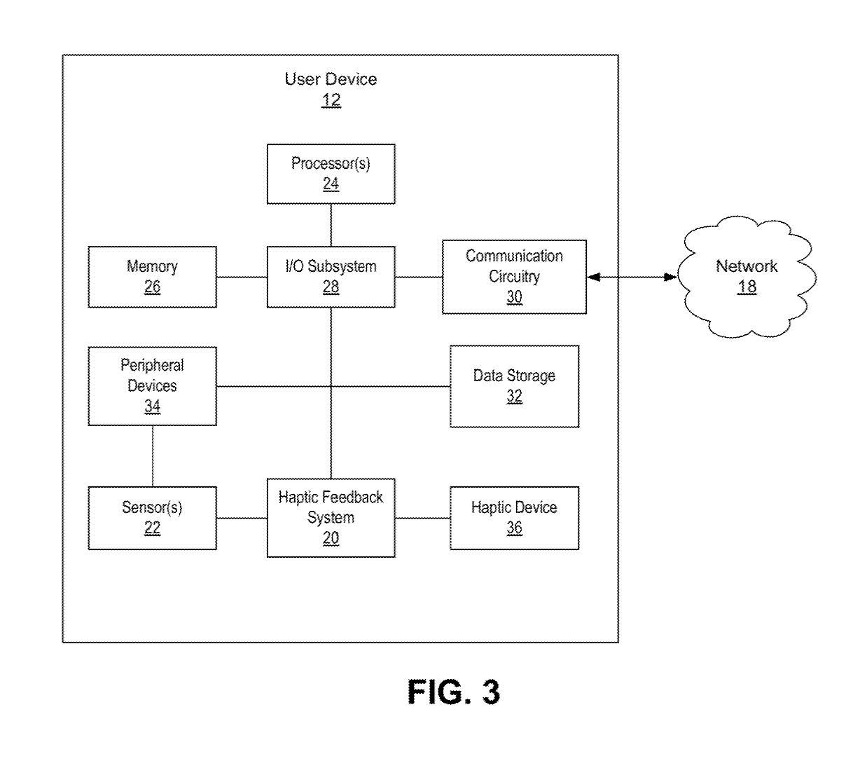

Turning to FIG. 3, at least one embodiment of a user device 12 of the system 10 of FIG. 1 is generally illustrated. It should be noted that the one or more sensors 22 are depicted as being integrated with the user device 12. In the illustrated embodiment, the user device 12 includes a processor 24, a memory 26, an input/output subsystem 28, communication circuitry 30, a data storage 32, peripheral devices 34, a haptic device 36, in addition to the haptic feedback system 20 and one or more sensors 22. As generally understood, the user device 12 may include fewer, other, or additional components, such as those commonly found in conventional computer systems. Additionally, in some embodiments, one or more of the illustrative components may be incorporated in, or otherwise from a portion of, another component. For example, the memory 26, or portions thereof, may be incorporated into the processor 24 in some embodiments.

The processor 24 may be embodied as any type of processor capable of performing the functions described herein. For example, the processor may be embodied as a single or multi-core processor(s), digital signal processor, microcontroller, or other processor or processing/controlling circuit. Similarly, the memory 26 may be embodied as any type of volatile or non-volatile memory or data storage capable of performing the functions described herein. In operation, the memory 26 may store various data and software used during operation of the user device 12 such as operating systems, applications, programs, libraries, and drivers. The memory 26 is communicatively coupled to the processor 24 via the I/O subsystem 28, which may be embodied as circuitry and/or components to facilitate input/output operations with the processor 24, the memory 26, and other components of the user device 12. For example, the I/O subsystem 28 may be embodied as, or otherwise include, memory, controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 28 may form a portion of a system-on-a-chip (SoC) and be incorporated, along with the processor 24, the memory 26, and other components of user device 12, on a single integrated circuit chip.

The communication circuitry 30 of the user device 12 may be embodied as any communication circuit, device, or collection thereof, capable of enabling communications between the user device 12 and at least one of the remote device 14 and external device/system/server 16 via the network 18. The communication circuitry 30 may be configured to use any one or more communication technology and associated protocols, as described above, to effect such communication.

The data storage 32 may be embodied as any type of device or devices configured for short-term or long-term storage of data such as, for example, memory devices and circuits, memory cards, hard disk drives, solid-state drives, or other data storage devices. In the illustrated embodiment, the user device 12 may maintain one or more application programs, databases, media and/or other information in the data storage 32. As described in greater detail herein, one or more applications related to haptic effects, including configurations and/or settings of haptic effects, may be stored in the data storage 32 and utilized by the haptic feedback system 20 for controlling the haptic device 36 to generate haptic effects.

The peripheral devices 34 may include one or more devices for interacting with the device 12, such as a display, a keypad and/or one or more audio speakers. In one embodiment, the device 12 may include a touch-sensitive display (also known as “touch screens” or “touchscreens”), in addition to, or as an alternative to, physical push-button keyboard or the like. The touch screen may generally display graphics and text, as well as provides a user interface (e.g., but not limited to graphical user interface (GUI)) through which a user may interact with the user device 12, such as accessing and interacting with applications stored in the data storage 32.

The haptic device 36 may include any known device configured to generate haptic effects, including, but not limited to, mechanical vibration and electrical stimulation. In one embodiment consistent with the present disclosure, the haptic device 36 includes a vibration actuator configured to generate vibrational effects. For example, the vibration actuator may be configured to generate vibrational effects in response to user input, such as when a user is interacting with one or more applications on the device 12 via the touch screen display. Additionally, or alternatively, the vibration actuator may be configured to generate vibrational effects in response to incoming communications on the user device 12, such as phone calls, text messages or emails, as well as notifications (e.g. tweets, post on social media app, push notifications from active applications, etc.).

The haptic device 36 may be configured to generate one of a plurality of different vibrational effects, wherein each vibrational effect may be associated with a haptic effect configuration stored within the data storage 32. The haptic device 36 may also be configured to provide haptic effects embedded in the incoming communications from the network 18. Each of the plurality of vibrational effects may correspond to a specific user input or incoming communication. For example, with respect to incoming communications, one of the vibrational effects may be specifically associated with an incoming phone call, wherein the vibrational effect may mimic the ringtone pattern and another vibrational effect may be specifically associated with an incoming text message, and may provide a short and abrupt pulse.

In one embodiment, the haptic device 36 may be configured to generate vibrational effects within the entire user device 12. In other embodiments, specific portions of the user device 12 may provide the vibrational effects generated by the haptic device 36. For example, vibrational effects may only be felt within one or more of the peripheral devices (e.g. display, keypad, etc.).

The haptic feedback system 20 is configured to communicate with the haptic device 36 and control generation of haptic effects from the haptic device 36. More specifically, the haptic feedback system 20 is configured to receive one or more signals indicative of user input and/or incoming communications with the user device 12 and, in response, generate and transmit a control signal to the haptic device 36 to cause generation of a haptic effect associated with the user input and/or incoming communication. As described in greater detail herein, the haptic feedback system 20 is configured to adjust one or more properties of vibrational effects, including, but not limited to, intensity (e.g. strength), waveform and duration, based, at least in part, on contextual characteristics of the user device and surrounding environment so as to provide an optimized haptic feedback effect to the user.

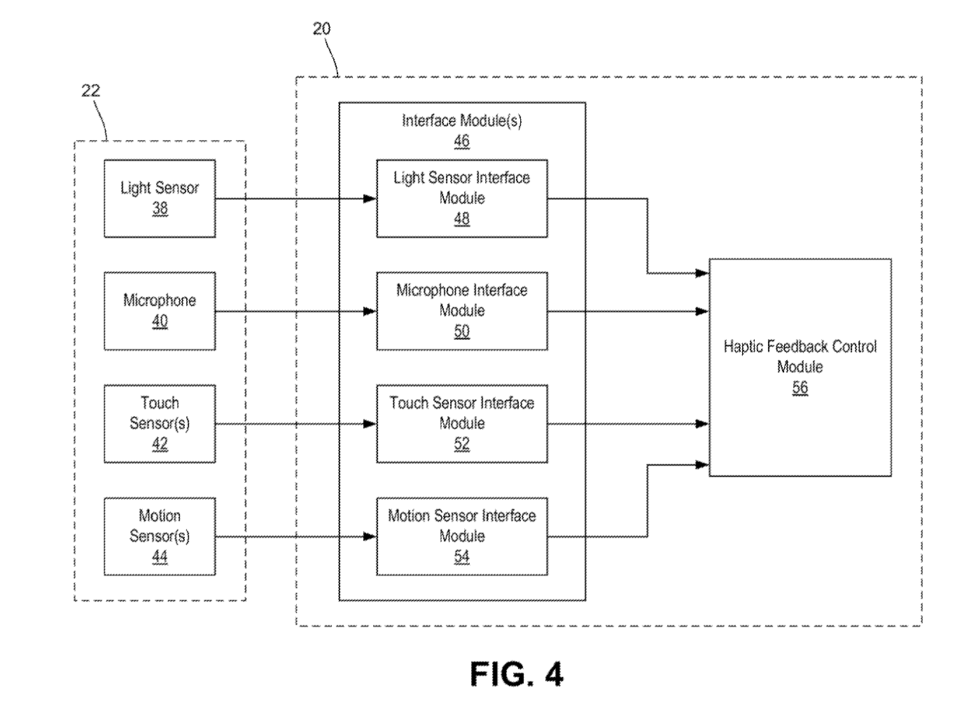

FIG. 4 is a block diagram illustrating a portion of the user device 12 of FIG. 3 in greater detail. As shown, the sensors 22 include a light sensor 38, a microphone 40, one or more touch sensors 42 and one or more motion sensors 44. It should be noted that FIG. 4 illustrates one embodiment of set of sensors included in a user device consistent with the present disclosure and by no means is meant to limit the kind and/or amount of sensors for use in a system and/or method consistent with the present disclosure. For example, a system and method consistent with the present disclosure may include more or less sensors than what is illustrated in FIG. 4. Examples of one or more sensors on-board the user device 12 may include, but should not be limited to, an ultraviolet (UV) sensor configured to sense UV irradiation to be used to further distinguish between natural light (e.g. sun) and artificial light which can indicate one characteristic of the surrounding environment (e.g. indoor or outdoor), a proximity sensor to produce sensory signals corresponding to the proximity of the device 12 to one or more objects and/or portions of the user, a global position system receiver configured to determine location data (e.g. coordinates) of the user device 12 and a system clock configured to determine date and time of day of the user device system.

In any case, the sensors 22 are configured to capture data related to the surrounding environment in relation to the user device 12 as well as characteristics of the device 12 itself, including active use of the device 12 (e.g. user is interacting with user device 12) and location of the device 12 in relation to the user (e.g. in physical contact with the user, stored in an article of clothing or personal items, etc.), all of which may be referred to local contextual information. The local contextual information with regard to the user device 12 may include, but is not limited to, ambient noise (also referred to as background noise) within the surrounding environment and ambient light surrounding or within the vicinity of the user device 12. The local contextual information may also include the user's possession, movement and/or use and interaction with device 12. For example, a user may be holding the device 12, the device 12 may be stored on the user, such as in a pocket, the device 12 may be placed in a personal item (e.g. hand bag, purse, back pack, etc.).

The ambient light sensor 38 may be embodied as any type of sensor configured to capture data and produce sensory signals from which the haptic feedback system 20 may determine contextual characteristics of the surrounding environment. In particular, the ambient light sensor 38 may be configured to capture data corresponding to ambient light within the surrounding environment surrounding or in the vicinity of the user device 12. As generally understood, ambient light may refer to sources of light that are naturally available (e.g. sun, moon, lightning) and/or artificial light (e.g. incandescent, halogen, fluorescent, LED, etc.). Similarly, the microphone 40 may be embodied as any type of audio recording device configured to capture local sounds within the environment surrounding the user device 12 and produce audio signals detectable and usable by the haptic feedback system 20 to determine contextual characteristics of the surrounding environment.

The one or more touch sensors 42 may be embodied as any type of sensor configured to capture touch data and produce sensory signals from which the haptic feedback system 20 may determine the local contextual characteristics of, for example, the user's active usage of the device 12. In particular, the device 12 may include at least one touch sensor 42 incorporated into the touch screen display, wherein the touch sensor 42 may be configured to capture touch data corresponding to a user's finger (or other body part configured to generate touch data) making contact with the touch screen display, or moving within close proximity of the display of the device 12 as a means of interacting with the device 12. One embodiment of a sensor 42 for use in the touch screen display may include a capacitive sensor.

Additionally, or alternatively, the device 12 may include touch sensors 42 positioned on other portions of the device 12 (e.g. the rear and/or sides of the device 12) and configured to capture touch data and produce sensory signals from which the haptic feedback system 20 may determine the whether the user is in physical possession of the device 12. In particular, touch sensors 42 in the back and/or side of the device 12 may be configured to capture data indicating whether the user is holding the device 12 in hand.

The one or more motion sensors 44 may be embodied as any type of sensor configured to capture motion data and produce sensory signals from which the haptic feedback system 20 may determine the user's possession of the device 12. In particular, the motion sensor 44 may be configured to capture data corresponding to the movement of the user device 12 or lack thereof. The motion sensor 44 may include, for example, an accelerometer or other motion or movement sensor to produce sensory signals corresponding to motion or movement of the device 12 and/or a magnetometer to produce sensory signals from which direction of travel or orientation can be determined. In another embodiment, the motion sensor 44 may include a gyroscope configured to sense angular velocity of the user device 12.

The motion sensor 44 may also be embodied as a combination of sensors, each of which is configured to capture a specific characteristic of the motion of the user device 12, or a specific characteristic of user movement. A motion sensor embodied as a combination of sensors may use algorithms, such as, for example, fusion algorithms, to correct and compensate the data from individual sensors and provide more robust motion sensing and detection context than each individual sensor can provide alone.

As shown, the haptic feedback system 20 includes interface modules 46 configured to process and analyze data captured from corresponding sensors 22 to determine one or more contextual characteristics based on analysis of the captured data. The haptic feedback system 20 further includes a haptic feedback control module 56 configured to control generation of haptic effects based, at least in part, on the contextual characteristics identified by the interface modules 46.

In the illustrated embodiment, the haptic feedback system 20 includes a light sensor interface module 48 configured to receive and analyze data captured by the light sensor 38, a microphone interface module 50 configured to receive and analyze data captured by the microphone 40, a touch sensor interface module 52 configured to receive and analyze data captured by the one or more touch sensors 42 and a motion sensor interface module 54 configured to receive and analyze data captured by the one or more motion sensors 44. It should be noted that the haptic feedback system 20 may include additional interface modules for receiving and analyzing data captured by additional sensors described above.

The light sensor interface module 48 is configured to receive data related to ambient light of the surrounding environment as captured by the light sensor 38. Upon receiving the captured ambient light data, the light sensor interface module 48 may be configured to process the data and identify a level of ambient light (i.e. level of available light surrounding or in the vicinity of the user device 12). As generally understood by one of ordinary skill in the art, the light sensor interface module 48 may be configured to use tiny known light analyzing methodology to identify ambient light levels. For example, the light sensor interface module 48 may include custom, proprietary, known and/or after-developed light sensing code (or instruction sets), hardware, and/or firmware that are generally well-defined and operable to receive sensory signals and identify, at least to a certain extent, a level of light, such as a brightness of light surrounding or in the vicinity of the user device 12.

The microphone interface module 50 is configured to receive sound data captured by the microphone 40. The microphone 40 includes any device (known or later discovered) for capturing local sounds within the environment surrounding the user device 12, including ambient noise. Such ambient noise may include, for example, one or more conversations between persons within the environment, audio output from other electronics (e.g. radio, television, etc.) within the surrounding environment, operation of equipment and/or vehicles within the environment, etc.

Upon receiving the sound data from the microphone 40, the microphone interface module 50 may be configured to use any known audio methodology to analyze and determine noise level of the sound data. For example, the microphone interface module 50 may include custom, proprietary, known and/or after-developed sound level and characteristics code (or instruction sets), hardware, and/or firmware that are generally well-defined and operable to receive sound data and determine a noise level, particularly a human-perceived loudness, such as a decibel level of the ambient noise surrounding or in the vicinity of the user device 12.

Additionally, or alternatively, the microphone interface module 50 may include custom, proprietary, known and/or after-developed sound identification and classification code (or instruction sets), hardware, and/or firmware that are generally well-defined and operable to receive sound data and determine environment audio classification of the sound data. For example, the microphone interface module 50 may include a classifier module configured to receive captured and analyze sound data, particularly time and frequency characteristics and determine context of the audio, such as, for example, context of conversations, gender of the voices, background music, crowd noise, motion sound, mechanical sound, etc. The use of audio classification may be combined with the other local contextual information described herein to determine one or more contextual characteristics more accurately.

The touch sensor interface module 52 is configured to receive touch data captured by the one or more touch sensors 42. Upon receiving the touch data from the one or more touch sensors 42, the touch sensor interface module 52 may be configured to identify a user contact with the user device 12, such as, for example, user contact with the touch screen display in the form of a touch event or user contact with other portions of the device 12 (e.g. rear and/or sides of the device 12), which may indicate that user possession and/or interaction with the device 12 (e.g. user interaction with GUI of device 12). The touch sensor interface module 52 may include custom, proprietary, known and/or after-developed touch detection code (or instruction sets) that are generally well-defined and operable to receive touch data and to identify a touch event.

The motion sensor interface module 54 is configured to receive motion data captured by the one or more motion sensors 44. Upon receiving the motion data from the one or more motion sensors 44, the motion sensor interface module 54 may be configured to identify movement of the device 12 such as, for example, the direction of movement and magnitude of movements, which may indicate user interaction with the device 12 and/or user possession of the device when combined with analyzing of touch data by the touch sensor interface module 52. The motion sensor interface module 54 may include custom, proprietary, known and/or after-developed motion detection code (or instruction sets) that are generally well-defined and operable to identify a motion event.

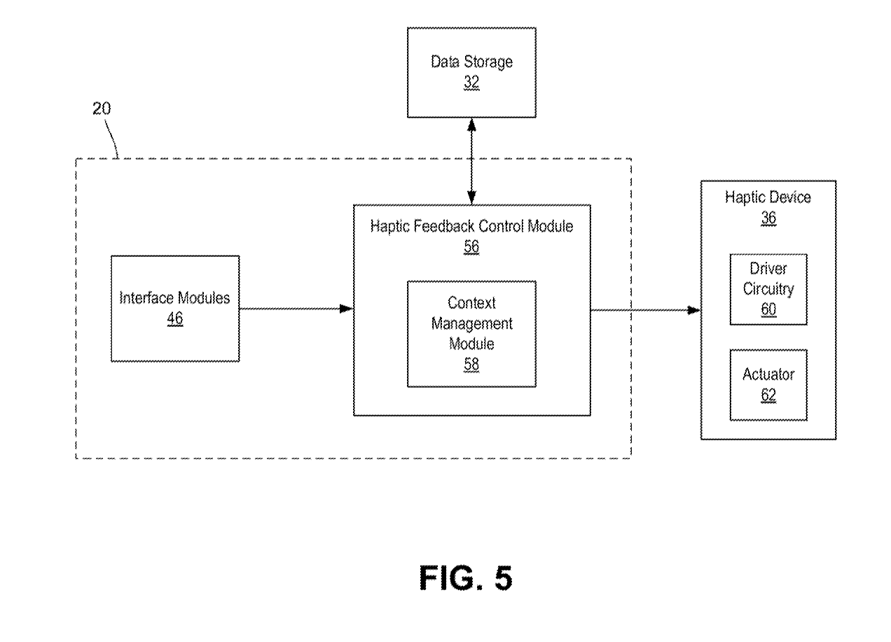

FIG. 5 is a block diagram illustrating another portion of the user device 12 of FIG. 3 in greater detail. As previously described, the haptic feedback control module 56 is configured to control generation of haptic effects by the haptic device 36 based, at least in part, on the contextual characteristics identified by the interface modules 46. As shown, the haptic feedback control module 56 includes a context management module 58 configured to receive data related to the identified contextual characteristics from the light sensor, microphone, touch sensor and motion sensor interface modules 48, 50, 52, 54. For example, the light sensor interface module 48 may provide data related to detected levels of ambient light in the surrounding environment and the microphone interface module 50 may provide data related to detected levels of ambient noise in the surrounding environment. Further, the touch sensor interface module 52 may provide data related to detected touch user input and or user contact with the device 12 and the motion sensor interface module 54 may provide data related to detected motion of the user device 12.

The context management module 58 is configured to evaluate the contextual characteristics and determine an overall local context assessment of the user device 12. In turn, the haptic feedback control module 56 is configured to dynamically adjust one or more properties of a vibrational effect configuration stored within the data storage 32 based on the overall local context assessment of the user device 12. In particular, the haptic feedback control module 56 is configured to adjust at least one of the intensity (e.g. strength), waveform and duration of a vibrational effect to be generated by the haptic device 36 based, at least in part, on the overall local context assessment.

The feedback control module 56 may be configured to generate a control signal including data related to a vibrational effect, including adjusted properties of the vibrational effect, and further transmit the control signal to a driver circuitry 60 of the haptic device 36. The driver circuitry 60 may include electronic components and circuitry for supplying a vibration actuator 62 with the required electrical current and voltage to cause the desired vibrational effect. The vibration actuator 62 may include one or more force applying mechanisms capable of applying a vibrotactile force to a user of the user device 12 (e.g. via the housing of the device 12).

In one scenario, a user may be having dinner in a busy restaurant. The user may be awaiting an incoming call on their mobile phone (e.g. user device 12). Although the user has set the volume on the phone at a maximum setting, the user may not be able to hear the ringtone of the incoming call due to the level of noise in the restaurant. The user may have also set the mobile phone to vibrate in connection with the ringtone. However, unless the user is directly holding the mobile phone, the pre-configured vibrational effects associated with the incoming call may be relatively weak and ineffective at alerting the user of the incoming call. Thus, the user may miss the incoming call altogether. A system consistent with the present disclosure, however, is configured to provide adaptive haptic effects (e.g. vibrational effects) based on the local contextual characteristics of the surrounding environment.

In this particular scenario, the sensors 22 are configured to capture data related to the characteristics of the restaurant. In particular, the microphone 40 may be configured to capture the local sound data within the restaurant and provide the captured sound data to the microphone interface module 50. In turn, the microphone interface module 50 may be configured to determine a level, such as a decibel level, of the ambient noise surrounding or in the vicinity of the user's mobile phone within the busy restaurant. The context management module 58 may evaluate at least the ambient noise level and determine an overall local context assessment of mobile phone in relation to the restaurant. In this instance, due to the busy restaurant, the ambient noise level may be sufficiently high, such that the context management module 58 determines that the surrounding environment (e.g. restaurant) may be sufficiently distracting, so much so that a user may miss an incoming notification, such as a phone call.

In turn, the feedback control module 56 is configured to dynamically adjust one or more properties of a vibrational effect associated with the incoming call based on the overall local context assessment of the restaurant. In this instance, the feedback control module 56 may be configured to increase the intensity (e.g. strength) and/or the duration of the vibrational effect to be generated by the vibration actuator 62 so as to compensate for the high noise level of the restaurant.

Additionally, there may be instances in which placement of the mobile phone may play a role in whether the user will be alerted to an incoming notification. For example, in the previous scenario, the user may have also placed the mobile phone in a pant pocket. Accordingly, the user may not be able to hear the ringtone alerting the user of the incoming call. The light sensor 38 may be configured to capture data corresponding to ambient light within the environment surrounding the mobile phone (e.g. the user's pants pocket) and provide the captured data to the light sensor interface module 48. In turn, the light sensor interface module 48 may be configured to determine a level of ambient light (i.e. level of available light surrounding or in the vicinity of the mobile phone), such as a brightness of the ambient light within the user's pants pocket.

The context management module 58 may evaluate the ambient light level, in addition to the ambient noise level provided by the microphone interface module 50, and determine an overall local context assessment of mobile phone in relation to at least the user's pants pocket, in addition to the restaurant. In this instance, the ambient light level may be relatively low, due in part to the little amount of light available in a pants pocket, and the ambient noise level may be sufficiently high due to the busy restaurant, such that the context management module 58 determines that the surrounding environment (e.g. pants pocket and restaurant) may be sufficiently distracting, so much so that a user may miss an incoming notification, such as a phone call. In particular, a low ambient light level may be associated with the mobile phone being positioned out of view and/or contact with the user.

In turn, the feedback control module 56 is configured to dynamically adjust one or more properties of a vibrational effect associated with the incoming call based on the overall local context assessment of the restaurant. In this instance, the feedback control module 56 may increase the intensity (e.g. strength) and/or the duration of the vibrational effect and/or vary the waveform of the vibrational effect to be generated by the vibration actuator 62, so as to compensate for the local context of the mobile phone.

In a similar scenario, the user may be sitting in a busy restaurant and may be actively using the mobile phone by periodically touching the touch screen display to input data to the phone. At one point, the user may divert their attention away from the phone to talk to a friend sitting in the next seat. In this moment, an incoming call may be received by the phone. Due to the noisy background in the restaurant, the user may not hear the ringtone and may not see the on-screen visual notification. In this instance, a touch sensor 42 incorporated in the touch screen display may capture touch data indicating active use of the phone and touch sensors 42 in other portions of the phone (e.g. rear and side portions) may capture data related to the user holding the phone. In turn, the context management module 58 may be configured to evaluate all contextual characteristics, including the active use of the device and possession of the phone in a user's hand, in addition to the noise level of the restaurant, to determine an overall local context assessment of the phone. In this particular scenario, although the restaurant may have a relatively high noise level, local context assessment may take into account that the user is in contact with and using the phone, such that little, if any, adjustment to the predefined haptic effect is necessary to alert the user of the incoming call. In this instance, the feedback control module 56 may even decrease the intensity, duration and/or pattern.

In yet another scenario, the user may be walking on a busy street around noontime with his or her mobile phone in a pants pocket when an incoming call is being received by the phone. The mobile phone rings but the user does not notice the ringtone due to the noise from the street. With the system and method described herein, the haptic feedback system 20 is configured to collect sensor data from the different sensors that are connected to the haptic feedback system 20. For example, the data from the light sensor 38 would indicate that the phone is in a relatively unlit area (phone is in a pants pocket). Data from the motion sensor 44 would indicate that the phone is moving, indicating that the phone is in the users possession. In the event the phone includes a GPS, data from the GPS would indicate that the phone is located on a street. Furthermore, the clock system would provide data indicating that it is currently noontime (e.g. a time commonly associated with busy lunch break crowds). Based on these contextual characteristics, the haptic feedback system 20 is configured to determine that the phone, more likely than not, is currently enclosed within a bag or container (e.g. pants pocket) and in the user's possession and in an area that is relatively busy. Accordingly, the haptic feedback system 20 may adjust haptic effects to compensate for the local context of the phone that may distract and/or prevent the user from hearing and/or feeling an alert of an incoming call, message, notification, etc.

It should be noted that, in one embodiment, the haptic feedback system 20 and sensors 22 described herein may be configured to continuously monitor the surrounding environment and automatically adjust haptic effects. This may be known as a “poll” mode.

In another embodiment, the haptic feedback system and sensors described herein may be configured to be activated when the haptic notification comes in (to be called “event driven” mode). When no event is triggered, the haptic feedback system and sensors coupled thereto may be configured to enter a low power state. The haptic feedback system and sensors may be configured to wake up from the low power state in response to an incoming event. Upon an incoming event, the haptic feedback system will then wake up the sensors coupled thereto from low power states and receive and analyze the captured data to determine contextual characteristics and global context assessment of the device for adjustment of the haptic effects accordingly. When the haptic notification is completed, the haptic feedback system and the sensors can then enter the lower power state, thereby conserving valuable battery power.

In yet another embodiment, the haptic feedback system and sensors may be configured to be activated when certain sensor events are captured by one or more of the sensors that are connected to the haptic feedback system. In such a system, one or more sensors are configured to capture certain sensor events, and upon the capture of certain sensor events, the haptic feedback system and other sensors in the system wake up from low power state and will capture the sensor data and will analyze the local contextual information and will determine to adjust haptic notification effects, in preparation of future haptic notification needs. The sensor events in such a system can be sensor data change threshold, or user movement characteristics change, or other events that are related to the local contextual characteristics of the user device and the environmental surroundings, or the global contextual characteristics such as location, or time.

In another embodiment, the haptic feedback system and the sensors may be configured to operate in a combination of the poll and event driven modes. For example, if certain sensors take a relatively long time to capture and provide data, these sensors may not be suited to operate in the event driven mode. In order to ensure the haptics feedback system described herein does not introduce noticeable delay to the user, the sensors that require a relatively long time to provide sensor data may operate only in the poll mode, in order to save battery life, it is important that the sensors configured to operate in the poll mode are monitored properly so that the corresponding sensor data is captured and updated with sufficient accuracy to the current local context. To address this, when the sensors are not operating in poll mode, the haptic feedback system may be configured to place the sensors in the low power state. When entering the poll mode, the haptic feedback system may be configured to wake up the sensors to a normal mode and receive the sensor data and then place the sensors back to a low power mode after the poll mode period is completed.

On the hand, sensors that are able to provide data at a relatively fast speed can be configured to operate in the event driven mode only. For example, only when a certain event is triggered, such as an incoming notification, the haptic feedback system may be configured to wake up the event driven sensors, read the sensor data, and place the event drive sensors in a low power mode.

In other embodiments, the device 12 may be configured to allow a user to manually toggle between off and on states of the poll mode. In other words, the user device 12 may be configured to provide the user with a means of activating and deactivating the haptic feedback system and automatic adjustment of haptic effects.

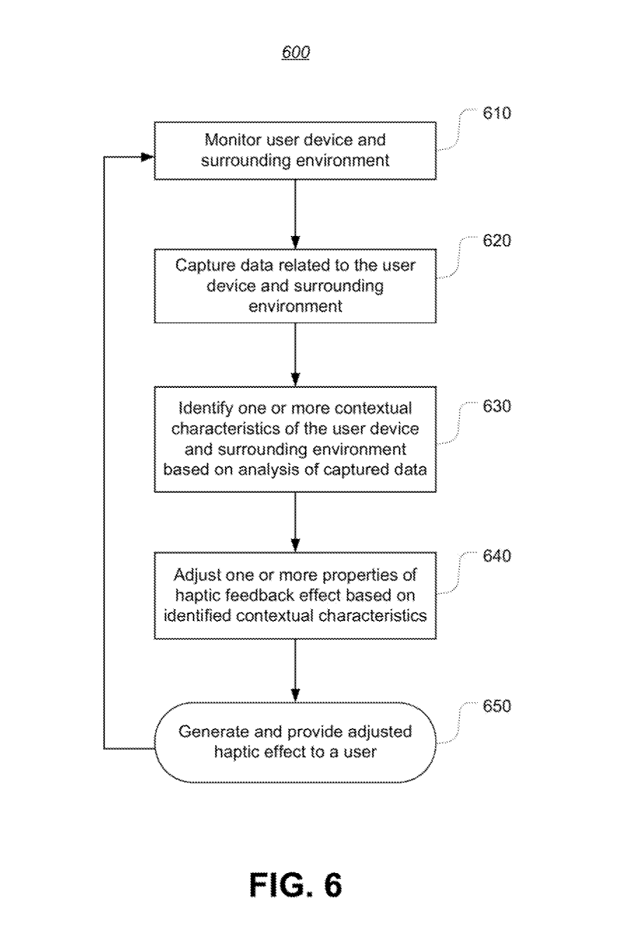

Turning now to FIG. 6, a flowchart of one embodiment of a method 600 for providing adaptive haptic effects to a user of a user device is generally illustrated. The method 600 includes monitoring a user device and surrounding environment (operation 610) and capturing data related to the user device and surrounding environment (operation 620). Data may be captured by one of a plurality of sensors. The data may be captured by a variety of sensors configured to detect various characteristics of the user device and the surrounding environment. The sensors may include, for example, at least one ambient light sensor, at least one microphone, one or more touch sensors and one or more motion sensors.

The method 600 further includes identifying one or more contextual characteristics of the user device and surrounding environment based on analysis of the captured data (operation 630). In particular, interface modules may receive data captured by associated sensors, wherein each of the interface modules may analyze the captured data to determine at least one of ambient noise level of the surrounding environment, ambient light level of the surrounding environment, physical contact between the device and the user and movement of the device. The method 600 further includes adjusting one or more properties of a haptic feedback effect based, at least in part, on the identified contextual characteristics of the user device and surrounding environment (operation 640). The method 600 further includes generating and providing the adjusted haptic feedback effect to a user of the user device (operation 660).

While FIG. 6 illustrates method operations according various embodiments, it is to be understood that in any embodiment not all of these operations are necessary. Indeed, it is fully contemplated herein that in other embodiments of the present disclosure, the operations depicted in FIG. 6 may be combined in a manner not specifically shown in any of the drawings, but still fully consistent with the present disclosure. Thus, claims directed to features and/or operations that are not exactly shown in one drawing are deemed within the scope and content of the present disclosure.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a system for providing adaptive haptic effects to a user of a user device in response to an incoming communication, as provided below.

Example 1 is a system for providing adaptive haptic feedback effects to a user of a user device in response to an incoming communication. The system may include at least one sensor to capture data related to a user device and/or a surrounding environment of the user device, at least one interface module to identify one or more contextual characteristics of the user device based on the captured data, a context management module to evaluate the one or more contextual characteristics and to determine a local context assessment of the user device based on the evaluation, a haptic feedback control module to adjust one or more parameters of one of a plurality of haptic effects based, at least in part, on the local context assessment and to generate a control signal having data related to the adjusted haptic effect, and a haptic device to generate the adjusted haptic effect in response to receipt of the control signal from the haptic feedback control module.

Example 2 includes the elements of example 1, wherein the at least one sensor is selected from the group consisting of a light sensor, a microphone, a touch sensor and a motion sensor, the light sensor and microphone to capture light and sound of the surrounding environment, respectively, and the touch sensor and motion sensor to capture user contact with and motion of the user device, respectively.

Example 3 includes the elements of example 2, wherein the at least one recognition module is configured to identify the one or more contextual characteristics of the user device and the surrounding environment based on at least one of the light in the surrounding environment, sound in the surrounding environment, user contact with the user device and motion of the user device.

Example 4 includes the elements of example 3, wherein the one or more contextual characteristics are selected from the group consisting of user possession of the user device, active user interaction with the user device, ambient light levels within surrounding environment and ambient noise levels within surrounding environment.

Example 5 includes the elements of any of examples 1 to 4, wherein each of the plurality of haptic effects includes a mechanical vibration effect.

Example 6 includes the elements of example 5, wherein the one or more parameters of the haptic effect is selected from the group consisting of intensity, waveform and duration of the vibration effect.

Example 7 includes the elements of any of examples of 5 to 6, wherein the haptic device includes a vibration actuator.

Example 8 includes the elements of any of examples 1 to 7, wherein each of the plurality of haptic effects corresponds to an associated one of a plurality of incoming communications to the user device from at least one of an internal notification system of the user device, a remote device and an external computing device, system, or server.

Example 9 includes the elements of example 8, wherein one of the plurality of incoming communications is selected from the group consisting of a phone call, text message, user input, email, push notification from a social media platform, internally stored calendar event notification and home appliance alert notification.

Example 10 is a method for providing adaptive haptic effects to a user of a user device in response to an incoming communication. The method may include receiving data related to a user device and/or a surrounding environment of the user device, identifying one or more contextual characteristics of the user device based on the data, evaluating the one or more contextual characteristics and determining a local context assessment of the user device based on the evaluation, adjusting one or more parameters of one of a plurality of haptic effects based, at least in part, on the local context assessment, and generating the adjusted haptic effect.

Example 11 includes the elements of example 10, further including capturing the data related to the user device and/or the surrounding environment of the user device with at least one sensor.

Example 12 includes the elements of example 11, wherein the at least one sensor is selected from the group consisting of light sensor, a microphone, a touch sensor and a motion sensor, the light sensor and microphone to capture light and sound of the surrounding environment, respectively, and the touch sensor and motion sensor to capture user contact with and motion of the user device, respectively.

Example 13 includes the elements of any of examples 10 to 12, wherein the one or more contextual characteristics are selected from the group consisting of user possession of the user device, active user interaction with the user device, ambient light levels within surrounding environment and ambient noise levels within surrounding environment.

Example 14 includes the elements of any of examples 10 to 13, wherein each of the plurality of haptic effects includes a mechanical vibration effect.

Example 15 includes the elements of example 14, wherein adjusting one or more parameters of a haptic effect includes adjusting at least one of intensity, waveform and duration of the vibration effect.

Example 16 includes the elements of any of examples 10 to 15, wherein each of the plurality of haptic effects corresponds to an associated one of a plurality of incoming communications to the user device.

Example 17 includes the elements of example 16, further including receiving one of a plurality of incoming communications from at least one of an internal notification system of the user device, a remote device and an external computing device, system, or server.

Example 18 includes the elements of example 17, wherein one of the plurality of incoming communications is selected from the group consisting of a phone call, text message, user input, email, push notification from a social media platform, internally stored calendar event notification and home appliance alert notification.

Example 19 comprises a system including at least a device, the system is arranged to perform the method set forth above in of any one of examples 10 to 18.

Example 20 comprises a chipset arranged to perform the method set forth above in of any one of examples 10 to 18.

Example 21 comprises at least one computer accessible medium having instructions stored thereon which, when executed by a computing device, cause the computing device to carry out the method set forth above in of any one of examples 10 to 18.

Example 22 comprises a device configured for providing adaptive haptic feedback effects, the device is arranged to perform the method set forth above in of any one of examples 10 to 18.

Example 23 comprises a system having means to perform the method set forth above in of any one of examples 10 to 18.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-19. (canceled)

20. A system for providing adaptive haptic feedback effects to a user of a user device in response to an incoming communication, said system comprising:
at least one sensor configured to capture data related to at least one of a user device and a surrounding environment of said user device;
at least one interface module configured to identify one or more contextual characteristics of said user device based on said captured data;
a context management module configured to evaluate said one or more contextual characteristics and to determine a local context assessment of said user device based on said evaluation;
a haptic feedback control module configured to adjust one or more parameters of one of a plurality of haptic effects based, at least in part, on said local context assessment and to generate a control signal having data related to said adjusted haptic effect; and
a haptic device configured to generate said adjusted haptic effect in response to receipt of said control signal from said haptic feedback control module.

21. The system of claim 20, wherein said at least one sensor is selected from the group consisting of a light sensor, a microphone, a touch sensor and a motion sensor, said light sensor and microphone configured to capture light and sound of the surrounding environment, respectively, and said touch sensor and motion sensor configured to capture user contact with and motion of the user device, respectively.

22. The system of claim 21, wherein said at least one recognition module is configured to identify said one or more contextual characteristics of said user device and said surrounding environment based on at least one of said light in the surrounding environment, sound in the surrounding environment, user contact with the user device and motion of the user device.

23. The system of claim 22, wherein said one or more contextual characteristics are selected from the group consisting of user possession of said user device, active user interaction with said user device, ambient light levels within surrounding environment and ambient noise levels within surrounding environment.

24. The system of claim 20, wherein each of said plurality of haptic effects includes a mechanical vibration effect.

25. The system of claim 24, wherein said one or more parameters of said haptic effect is selected from the group consisting of intensity, waveform and duration of said vibration effect.

26. The system of claim 24, wherein said haptic device includes a vibration actuator.

27. The system of claim 20, wherein each of said plurality of haptic effects corresponds to an associated one of a plurality of incoming communications to said user device from at least one of an internal notification system of said user device, a remote device and an external computing device, system, or server.

28. The system of claim 27, wherein one of said plurality of incoming communications is selected from the group consisting of a phone call, text message, user input, email, push notification from a social media platform, internally stored calendar event notification and home appliance alert notification.

29. A method for providing adaptive haptic effects to a user of a user device in response to an incoming communication, said method comprising:
receiving data related to at least one of a user device and a surrounding environment of said user device;
identifying one or more contextual characteristics of said user device based on said data;
evaluating said one or more contextual characteristics and determining a local context assessment of said user device based on said evaluation;
adjusting one or more parameters of one of a plurality of haptic effects based, at least in part, on said local context assessment; and
generating said adjusted haptic effect.

30. The method of claim 29, further comprising capturing said data related to said at least one of user device and said surrounding environment of said user device with at least one sensor.

31. The method of claim 30, wherein said at least one sensor is selected from the group consisting of a light sensor, a microphone, a touch sensor and a motion sensor, said light sensor and microphone to capture light and sound of the surrounding environment, respectively, and said touch sensor and motion sensor to capture user contact with and motion of the user device, respectively.

32. The method of claim 29, wherein said one or more contextual characteristics are selected from the group consisting of user possession of said user device, active user interaction with said user device, ambient light levels within surrounding environment and ambient noise levels within surrounding environment.

33. The method of claim 29, wherein each of said plurality of haptic effects includes a mechanical vibration effect.

34. The method of claim 33, wherein adjusting one or more parameters of a haptic effect comprises adjusting at least one of intensity, waveform and duration of said vibration effect.

35. The method of claim 29, wherein each of said plurality of haptic effects corresponds to an associated one of a plurality of incoming communications to said user device.

36. The method of claim 35, further comprising receiving one of a plurality of incoming communications from at least one of an internal notification system of said user device, a remote device and an external computing device, system, or server.

37. The method of claim 36, wherein one of said plurality of incoming communications is selected from the group consisting of a phone call, text message, user input, email, push notification from a social media platform, internally stored calendar event notification and home appliance alert notification.

38. A system including at least a device, the system being arranged to perform the method of claim 29.

39. A chipset arranged to perform the method of claim 29.

40. At least one computer accessible medium having instructions stored thereon which, when executed by a computing device, cause the computing device to carry out the method according to claim 29.

41. A device configured for providing adaptive haptic feedback effects, the device being arranged to perform the method of claim 29.

42. A system having means to perform the method of claim 29.
